(19) United States
(12) Patent Application Publication
(10) Pub. No.: US 2009/0314125 A1
(43) Pub. Date: Dec. 24, 2009

(54) HAND GUARD FOR MOTORCYCLE HANDLEBAR

(76) Inventor: Edoardo Mentasti, Varese (IT)

Correspondence Address: Steinfl & Bruno, 301 N Lake Ave Ste 810, Pasadena, CA, 91101, US

(21) Appl. No.: 12/374,422

(22) PCT Filed: Jul. 20, 2006
(86) PCT No.: PCT/IT06/00551

§ 371 Date: Aug. 5, 2009

(51) Int. Cl. B62J 23/00; B62J 27/00

(52) U.S. Cl. 74/551.8; 280/304.3

(57) ABSTRACT

A hand guard for a grip and lever terminal (2) of a motorcycle handlebar (3), including a convex outer surface (lout) guard (1) having a bracket protrusion (4) extending from its rear surface for fixing the guard (1) to the handlebar (2), comprises a monodirectional, limited rotation joint (5) between the fixing bracket (4) and the guard (1) for allowing downward rotation by at least 80°, contrasted by an elastic element (6). The hand guard may optionally further comprise a second monodirectional, limited rotation joint allowing a relative rotation of the first joint (5) and guard (1) assembly around a vertically oriented axis of rotation monodirectionally toward the front wheel fork head of the motorcycle.

The present invention relates to motorcycles and more in particular to comfort and/or protective accessories of motorcycles and specifically to hand guards applicable in front of the two grip and lever terminals of the handlebar.

Hand guards in the form of a convex outer surface guard generally of a molded high resistance plastic material, with a bracket extending from the rear surface for fixing the guard to the handlebar are well known and employed especially on “off road” motorcycles to protect the hands from wind, mud, stones, gravel and other dangerous projectiles thrown by the rear wheels of preceding motorcycles and as a protection of the hand and the lever in case of falls to the ground.

Hand guards may prevent accidental impacts on the lever of the front wheel brake in the event of a contact with another racer, event that may hurl the rider frontwise and set the motorcycle in an awful lengthwise spin.

The use of hand guards has not become generalized apart in the off road domain because of concerns on the possibility that in case of accidental impacts the dynamic of which is such to tend to catapult frontwise the rider, the hand(s) may remain entrapped by the guard instead of being free to lift off the grip and lever, causing wrist fractures.

The applicants have found a new construction of a hand guard that, while preserving the protective function of the guard in case of “normal” accidental falls to the ground because of insufficient grip during a high speed turn, will ensure by contrast that in the event of an accident that may hurl the rider frontwise, the hand guard will safely yield to the dynamic force exerted by the writs or outer surface of the hand of the rider by rotating downward to permit a substantially unobstructed release of the hand engaged by the upper rim of the guard.

The invention rests on the introduction of a monodirectional, limited rotation joint between the fixing bracket and the guard for allowing a downward rotation by at least 45° or even by about 80°, contrasted by an elastic element.

The monodirectionality of the limited rotation permitted by the joint preserves a protective function of the guard in case of a slide on the track by not permitting to the guard to lift up thus offering a protection to the gloved hand from rubbing on the track surfacing and/or present a direct impact of the lever that if it brakes would impede prosecution of the race while promptly yielding in case of pressure exerted by the hand or wrist of the rider on the upper rim of the guard in case of the rider being flung frontwise because of an accidental impact with a resisting obstacle.

The invention is defined in the annexed claims.

### BRIEF DESCRIPTION OF THE DRAWINGS

FIGS. 1 and 2 are views from front and from above, respectively, of a hand guard of this invention.

FIGS. 3 and 4 are a cross section and a plan view of a monodirectional, limited rotation joint, according to a first embodiment.

FIGS. 5 and 6 are a cross section and a plan view, respectively, of a monodirectional, limited rotation joint, according to an alternative embodiment.

FIGS. 7 and 8 illustrate the action of the monodirectional, limited rotation joint that sustains the guard.

FIGS. 9 and 10 are a cross section and a plan view of a further embodiment of this invention, including a second monodirectional, limited rotation joint acting about an axis of rotation orthogonal to the axis of rotation of the main joint.

FIGS. 11 and 12 are perspective views of the hand guard assembly according to the embodiment of FIGS. 9 and 10, showing the respective functions of the two joints.

### DESCRIPTION OF SEVERAL PREFERRED EMBODIMENTS OF THE INVENTION

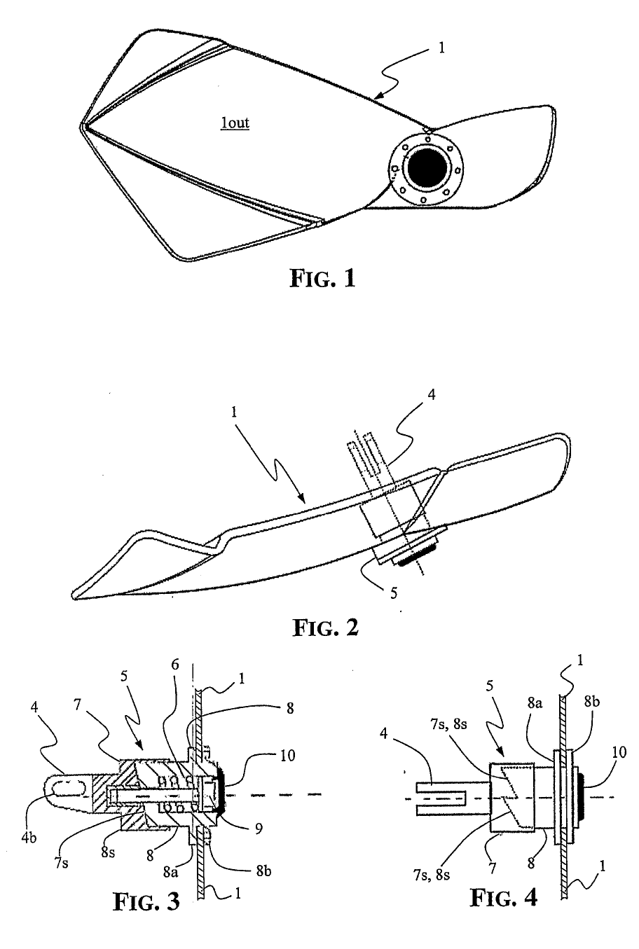

FIGS. 1 and 2 are views from front and from above of a prototype test sample of a hand guard made according to the present invention, wherein a molded reinforced plastic shield 1, functionally shaped with a generally convex front surface 1 out, is installed on a joining device 5 terminating with a fork-shaped fixing bracket 4.

The bracket appendix 4, provided with slotted holes 4b for the passage of the stem of a fixing bolt, for solidly mounting the hand guard assembly onto a dedicated lug (not shown in the figures) fastened to the handlebar, is, according to this invention, connected to the guard 1 through a monodirectional, limited rotation joint, indicated as a whole with 5 in the figures.

FIGS. 3 and 4 are a cross section and a plan view of the monodirectional, limited rotation joint, according to a first embodiment.

According to this embodiment, the monodirectionality and the angular limitation of rotation of the joint are implemented by two telescopically coupled cylindrical parts 7 and 8, having specularly inclined matching surfaces 7s and 8s that are loaded in a head-to-head abutment by a pre-compressed spring 6. Precompression of the spring 6, by driving the assembly and load adjusting screw 9 into an axial threaded hole at the bottom of the cylindrical cavity of the fixed part 7 of the joint.

A plastic cap 10 closes the cavity that accommodates the contrasting spring 8 and the assembly and pre-loading screw 9.

The fixed part 7 of the joint is fastened to the handlebar. In the shown embodiment, part 7 of the joint terminates with a fork-shaped mounting bracket 4, provided with the slotted holes 4b. A projecting lug, fastened to the handlebar, (not shown in the figures) is received between the two arms of the fork bracket 4 and a bolt is eventually tightened to fasten the hand guard to the handle bar in the desired position, as allowed by the slotted holes 4b.

As noted, the fixed part 7 has a cylindrical cavity for telescopically receiving the cylindrical part 8 of the bottom of which is machined to form two circumferential sectors, each smaller than 180°, generally of about 1700, sequentially inclined in a saw-tooth fashion.

Part 8 telescopically fits into the cylindrical cavity of part 7 and has an end surface specularly machined in two circularly disposed inclined sectors, matching those of the bottom surface of the cylindrical cavity of part 7.

Part 8 sustains the plastic hand guard 1 that, in the sample embodiment shown, is held between a flange 8a and a counter flange 8b.

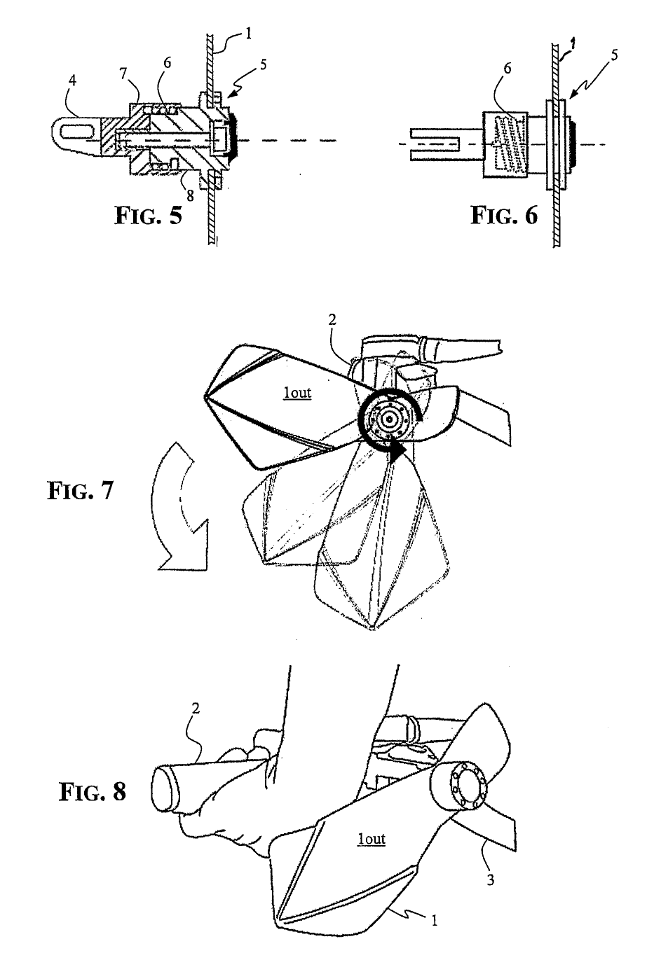

FIGS. 5 and 6 are respectively a cross section and a plan view of a monodirectional, limited rotation joint, according to an alternative embodiment of this invention and wherein parts having the same function of equivalent parts of the device of the previously described embodiment of FIGS. 4 and 5 are identified with the same numbers.

According to this alternative embodiment, the monodirectionality and limitation of the rotation of the guard holding part 8 in relation to the fixed part 7 of the joint, are established by a torsion spring 6.

Of course other equivalent monodirectional, limited rotation joints, of different construction from those of the above described embodiments can be employed. In particular the function of the contrasting spring may be implemented by employing an elastomer either in a torsion or deflection contrasting mode, as will be easily recognized by a skilled artisan.

FIGS. 7 and 8 illustrate the action of the monodirectional, limited rotation joint that sustains the guard. As depicted the monodirectional (downward) rotation of the guard when so urged by the hand of the rider takes place about a substantially horizontal axis of rotation.

Optionally, for further enhancing the purposely introduced monodirectional yielding properties of the hand guard assembly of this invention, to the function of the above described main or primary monodirectional, limited rotation joint sustaining the guard in order not to impede the exiting of the hand from the space between the lever and the guard, may be associated a distinct cooperative function of a second or ancillary monodirectional, limited rotation joint permitting a monodirectional sideway bending of the assembly toward the front wheel fork head of the motorcycle, also including an elastically contrasting element.

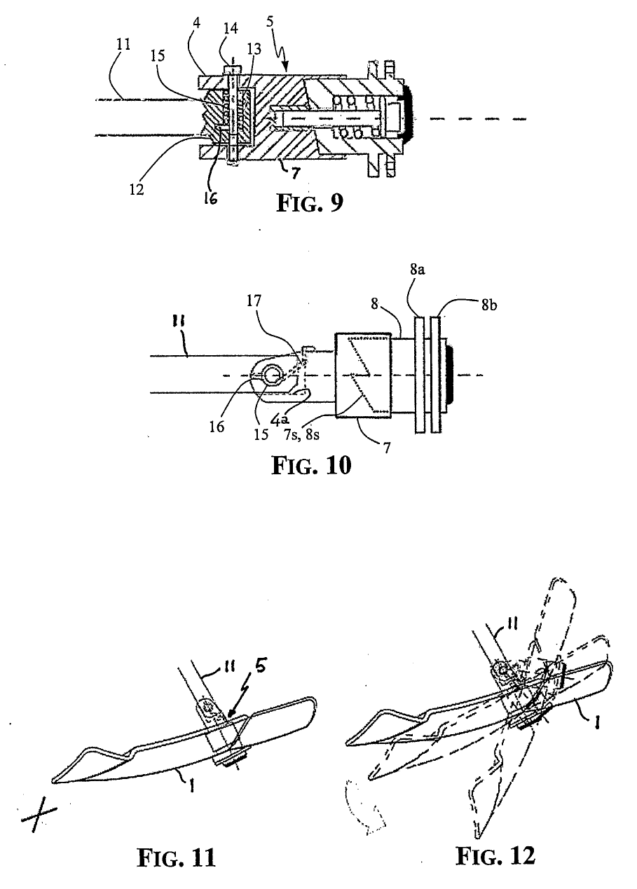

FIGS. 9 and 10 show an embodiment of such an optional multiple joint assembly for supporting the hand guard.

In the sample illustration are reproduced the features that provide for the monodirectional, limited rotation about a generally horizontal axis of rotation of the joint 5, according to the embodiment of FIGS. 3 and 4.

As may be observed in the sectional view of FIG. 9 and on the view from above of FIG. 10, the bracket termination of the joint assembly couples with a terminal lug 12 of a support arm 11 solidly fastened to the handlebar. The fixing bolt of the prior embodiments is this case a connection pin 14, a threaded end of which is driven in a threaded hole in one of the two arms of the fork termination, such to allow a relative rotation of the main joint assembly 5 relative to the supporting lug 12. The through hole of the lug 12 has an enlarged portion forming a cylindrical cavity 13 that accommodates a torsion spring 15, a bent wire end 16 of which is retained in a radial cavity of the cylindrical wall and the other wire end 17 tangentially extends to meet at an angle of inclination the inner end surface of the fork bracket.

As may be observed in the view from above of FIG. 10, the bracket termination 4 of the part 7 of the main limited rotation joint 5 has a bridging portion 4a closing the side of the termination toward the outer end of the handgrip of the handlebar, that impedes any relative rotation (clockwise in the figure) of the bracket around the pivot pin 14 of the joint while allowing rotation in the opposite direction. The tangentially extending wire end 17 of the torsion spring 15 exerts a contrasting force by elastically yielding when the hand guard is urged to a frontwise direction by the hand of the rider.

FIGS. 11 show the hand guard assembly when not solicited and FIG. 12 when it is urged downward and/or forward by the hand-wrist of the rider. In the latter situation, the allowed monodirectional limited rotations will be anticlockwise about both the horizontally oriented axis of rotation and about the vertically oriented axis of rotation, for the case of the right hand side hand guard shown in the figures. Conversely, in the case of the left hand hand guard, the permitted rotations will be both clockwise.

Of course, also the secondary joint function can be implemented with any suitable modirectional, limited rotation joint including an elastically contrasting element. For example, the joint assembly of FIGS. 3 and 4, or of FIGS. 5 and 6 may be connected instead of through a fork shaped fixing bracket, by a relatively short robust elastomer stem restrained on the grip and lever side by a rigid channel projecting from the handle bar stand or from part 7 of the joint, containing the elastomer stem for allowing, besides the monodirectional downward rotation ensured by the joint 5, also a monodirectional sideway bending of the elastomer stem out of the containing and side-restraining rigid channel toward the front/wheel fork head, under the force of the hand urged against the upper rim of the guard 1 that will tend to divaricate frontwise the hand guard 1.

As it will be readily recognized, the rotating part 8 of the main joint 5 may be molded in a monolithic piece together with the hand guard 1, already shaped and ready to receive the assembling screw and the eventual compression or torsion spring, and to fit with the other part 7 of the primary joint 5, thus without requiring any fastening fixtures between the part 8 and the guard 1.

1. Hand guard for a grip and lever terminal of a motorcycle handlebar, including a convex outer surface guard having a bracket protrusion extending from its rear surface for fixing the guard to the handlebar, the hand guard further comprising a monodirectional, limited rotation joint between said fixing bracket and the convex outer surface guard allowing downward rotation by at least 80°, contrasted by an elastic element.

2. The hand guard of claim 1, wherein said joint comprises two telescopically coupled cylindrical parts, one of which is connected to said fixing bracket and the other to the guard, with specularly inclined surfaces, axially loaded in a head-to-head abutment by a compression spring.

3. The hand guard of claim 1, wherein said joint comprises two coupled cylindrical parts, the monodirectional, limited rotation of one part relative to the other part connected to said fixing bracket being contrasted by a torsion spring.

4. The hand guard of claim 1, further comprising a second monodirectional, limited rotation joint allowing a relative rotation of said first joint and said guard assembly around a vertically oriented axis of rotation monodirectionally toward the front wheel fork head of the motorcycle.

5. The hand guard of claim 4, wherein said second joint is composed of a fork shaped bracket terminal of said first monodirectional, limited rotation joint pivotally connected to a mounting lug by a pivot pin, said fork shaped bracket terminal having a bridging portion closing the side of the fork termination toward the outer end of the handgrip of the handlebar for preventing any relative rotation in that direction of said mounting lug, and a torsion spring elastically resisting relative rotation in the opposite direction toward the front wheel fork head of the motorcycle.

6. The hand guard of claim 4, wherein said joint is connected to said fixing bracket by a side restrained elastomer stem allowing a monodirectional sideway bending on the stem toward the front wheel fork head of the motorcycle.
